(19) United States
(12) Patent Application Publication
(10) Pub. No.: US 2008/0057434 A1
(43) Pub. Date: Mar. 6, 2008

(54) METHOD OF PRODUCING NON-MAGNETIC ONE-COMPONENT TONER FOR DEVELOPING ELECTROSTATIC IMAGE

(75) Inventor: Muneharu Itoh, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ZEON CORPORATION, Tokyo (JP)

(21) Appl. No.: 11/848,513

(22) Filed: Aug. 31, 2007

(30) Foreign Application Priority Data
Aug. 31, 2006 (JP) 2006-235639

(51) Int. Cl. G03G 9/093

(52) U.S. Cl. 430/137.15

(57) ABSTRACT

The present invention is to provide a method of producing a non-magnetic one-component toner for developing an electrostatic image which is well-balanced between shelf stability and fixing ability at low temperature and has a good charge property so that printing performance is excellent from the viewpoint of hardly producing printing soiling such as fogs or the like.
The method of producing the non-magnetic one-component toner for developing an electrostatic image comprising the steps of: a suspension process (A) of obtaining a suspension having droplets of a polymerizable monomer composition for core dispersed by suspending the polymerizable monomer composition for core comprising at least a polymerizable monomer for core and a colorant in an aqueous dispersion medium containing a dispersion stabilizer; a core particle forming process (B) of forming a core particle comprising a binder resin and a colorant by suspending and polymerizing the suspension in the presence of a polymerization initiator; and a shell layer forming process (C) of forming a shell layer to cover the core particle by adding polymerizable monomers for shell to a core particle dispersion liquid having the core particles dispersed in an aqueous dispersion medium followed by polymerization in the presence of a polymerization initiator, wherein, in the process (C), 0.1 to 10 parts by weight of a polymerizable monomer for shell containing at least a polymerizable tertiary amino compound having a structure represented by the following Chemical formula 1 with respect to the polymerizable monomer for core of 100 parts by weight is added to the core particle dispersion liquid as the polymerizable monomers for shell and polymerized, thereby, the shell layer comprising a polymer having a glass transition temperature from 70 to 120° C. is formed: 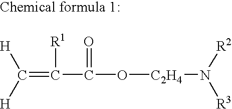
wherein, R¹, R², and R³ independently represent hydrogen or an alkyl group having 1 to 4 carbon atoms respectively.

### BACKGROUND OF THE INVENTION

1. Field of the Invention

The present invention relates to a method of producing a non-magnetic one-component toner for developing an electrostatic image used for development of an electrostatic latent image in an electrophotography, an electrostatic recording method, an electrostatic printing process or the like. Particularly, the present invention relates to a method of producing a non-magnetic one-component toner for developing an electrostatic image which is well-balanced between shelf stability and fixing ability at low temperature and also excellent in printing performance. Hereinafter, “a non-magnetic one-component toner for developing an electrostatic image” may be simply referred to as “a toner”.

2. Description of the Related Art

In an image forming device such as an electrophotograph forming device, an electrostatic recording device, an electrostatic printing device or the like, a method of forming a desired image by developing an electrostatic latent image formed on a photosensitive member with a toner for developing an electrostatic image is widely employed. For example, in an electrophotograph forming device employing the electrophotography, a desired printed product is obtained through a series of image forming processes comprising: a charging process in which a surface of a photosensitive member is uniformly charged; an exposing process in which an electrostatic latent image is formed on the surface of the photosensitive member by exposure, a developing process in which the electrostatic latent image thus formed is developed with a toner comprising toner particles which are incorporated with an external additive and so on as needed; a transferring process in which the toner is transferred to a recording medium such as a paper, an OHP sheet or the like; and a fixing process in which the transferred toner is fixed to the recording medium.

In said image forming processes, a process which consumes the most energy is the fixing process of fixing a toner to a recording medium. As a method of fixing, fixing a toner by heating and pressing with a fixing roller is widely used. Normally, in this method, the temperature of the fixing roller upon fixing needs to be controlled to 150° C. or more, and the electric power is used as an energy source for controlling the temperature. Decreasing the temperature of the fixing roller upon fixing is demanded from the viewpoint of energy saving. Capability of fixing at low temperature is also effective in high-speed printing; thus, decreasing the temperature of the fixing roller upon fixing is also demanded from the viewpoint of increasing the speed of printing.

To meet the demand for an energy-saving image forming device and high-speed image printing, lowering of fixing temperature of a toner is studied. As a method of obtaining a toner excellent in fixing ability at low temperature, for example, a method of decreasing the glass transition temperature (Tg) of a toner has been proposed. For lowering of fixing temperature of a toner, it is necessary to control thermal properties of a resin comprising the toner. However, when the glass transition temperature (Tg) of the toner is excessively decreased, there is a problem that a so called “blocking” phenomenon, in which toner particles fuse each other, occurs and shelf stability of the toner deteriorates. Accordingly, development of a toner which can be fixed at low temperature with maintaining shelf stability (an anti-blocking property) is demanded.

In order to meet the demand for development of said toner, as a method of obtaining a toner having both shelf stability (an anti-blocking property) and fixing ability at low temperature, a production method of a toner having a core-shell type structure in which a substance having a low softening point is covered with a substance having a higher softening point by polymerization is proposed.

For example, Japanese Patent Application Laid-Open (JP-A) No. 2001-281931 discloses a method of producing a core-shell type toner for developing an electrostatic image, wherein methyl methacrylate as a polymerizable monomer for shell of 3 parts by weight is added with respect to a polymerizable monomer for core of 100 parts by weight followed by polymerization. Also, JP-A No. 2004-286801 discloses a method of producing a core-shell type colored toner wherein methyl methacrylate as a polymerizable monomer for shell of 1 part by weight is added with respect to a polymerizable monomer for core comprising dialkyl amino alkyl(meth)acrylate of 100 parts by weight followed by polymerization.

However, although the toners produced by these methods have a low fixing temperature and an excellent shelf stability, production of fogs in the early stage of printing may not be prevented.

Also, JP-A No. Hei. 5-62237 discloses a microcapsule wherein a polymer constituting a capsule shell is obtained by polymerization of a vinyl monomer through decomposition of a polymeric initiating azo group having a polymer structure of a polyurea resin, a polyurethane resin, a polyamide resin or the like, and a production method thereof. However, the microcapsule may be inferior in fixing ability at low temperature when used as a toner since it is excellent in mechanical strength due to using said resins or the like.

An object of the present invention is to provide a method of producing a non-magnetic one-component toner for developing an electrostatic image which is well-balanced between shelf stability and fixing ability at low temperature and has a good charge property so that printing performance is excellent from the viewpoint of hardly producing printing soiling such as fogs or the like.

### SUMMARY OF THE INVENTION

As the result of diligent researches made to attain the above object, the inventor of the present invention found out that by adding a polymerizable tertiary amino compound having a structure represented by the following Chemical formula 1 as polymerizable monomers for shell in the process of forming a shell layer of a non-magnetic one-component toner for developing an electrostatic image having a core-shell type structure, shelf stability and fixing ability at low temperature of a non-magnetic one-component toner for developing an electrostatic image can be well-balanced, and further, from the viewpoint of charge property, a good initial charge speed is performed and fogs are hardly produced in the early stage of printing along with a stable appropriate charge property so that printing durability is excellent hardly causing fogs even after continuous printing of plural images.

A method of producing a non-magnetic one-component toner for developing an electrostatic image of the present invention comprises steps of: a suspension process (A) of obtaining a suspension having droplets of a polymerizable monomer composition for core dispersed by suspending the polymerizable monomer composition for core comprising at least a polymerizable monomer for core and a colorant in an aqueous dispersion medium containing a dispersion stabilizer; a core particle forming process (B) of forming a core particle comprising a binder resin and a colorant by suspending and polymerizing the suspension in the presence of a polymerization initiator; and a shell layer forming process (C) of forming a shell layer to cover the core particle by adding polymerizable monomers for shell to a core particle dispersion liquid having the core particles dispersed in an aqueous dispersion medium followed by polymerization in the presence of a polymerization initiator, wherein, in the process (Cy, 0.1 to 10 parts by weight of a polymerizable monomer for shell containing at least a polymerizable tertiary amino compound having a structure represented by the following Chemical formula 1 with respect to the polymerizable monomer for core of 100 parts by weight is added to the core particle dispersion liquid as the polymerizable monomers for shell and polymerized, thereby, the shell layer comprising a polymer having a glass transition temperature from 70 to 120° C. is formed: 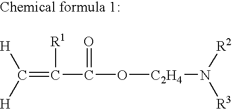
wherein, R¹, R² and R³ independently represent hydrogen or an alkyl group having 1 to 4 carbon atoms respectively.

In accordance with the method of producing the non-magnetic one-component toner for developing an electrostatic image of the present invention, it is able to produce a toner for developing an electrostatic image which is well-balanced between shelf stability and fixing ability at low temperature and has a good charge property so that printing performance is excellent from the viewpoint of hardly producing printing soiling such as fogs or the like.

### DETAILED DESCRIPTION OF THE INVENTION

A method of producing a non-magnetic one-component toner for developing an electrostatic image comprises steps of: a suspension process (A) of obtaining a suspension having droplets of a polymerizable monomer composition for core dispersed by suspending the polymerizable monomer composition for core comprising at least a polymerizable monomer for core and a colorant in an aqueous dispersion medium containing a dispersion stabilizer; a core particle forming process (B) of forming a core particle comprising a binder resin and a colorant by suspending and polymerizing the suspension in the presence of a polymerization initiator; and a shell layer forming process (C) of forming a shell layer to cover the core particle by adding polymerizable monomers for shell to a core particle dispersion liquid having the core particles dispersed in an aqueous dispersion medium followed by polymerization in the presence of a polymerization initiator, wherein, in the process (C), 0.1 to 10 parts by weight of a polymerizable monomer for shell containing at least a polymerizable tertiary amino compound having a structure represented by the following Chemical formula 1 with respect to the polymerizable monomer for core of 100 parts by weight is added to the core particle dispersion liquid as the polymerizable monomers for shell and polymerized, thereby, the shell layer comprising a polymer having a glass transition temperature from 70 to 120° C. is formed: 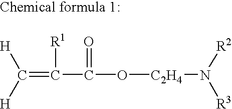
wherein, R¹, R² and R³ independently represent hydrogen or an alkyl group having 1 to 4 carbon atoms respectively.

Hereinafter, the method of producing the non-magnetic one-component toner for developing an electrostatic image of the present invention will be described in order.

1. Preparation Process of Polymerizable Monomer Composition for Core

In the present invention, firstly, a polymerizable monomer for core to be a material for the first binder resin, a colorant, and as needed, other additives are mixed together to prepare a polymerizable monomer composition for core.

A method of preparing the polymerizable monomer composition for core is not particularly limited. It is preferable to perform mixing so that the colorant and other additives are dissolved or uniformly and finely dispersed as much as possible in the polymerizable monomer composition for core. Such mixing can be performed by means of, for example, an in-line type emulsifying and dispersing machine (product name: MILDER; manufactured by. Ebara Corporation), a media type dispersing machine (product name: PICO GRAIN MILL; manufactured by: IKA Works Inc.) or the like so as to prepare the polymerizable monomer composition for core.

In the present invention, a polymerizable monomer means a compound which can be polymerized. As a main component of the polymerizable monomer for core, a monovinyl monomer is preferably used. As the monovinyl monomer, for example, there may be styrene; a styrene derivative such as vinyl toluene, α-methylstyrene or the like; acrylic acid and methacrylic acid; acrylic acid ester such as methyl acrylate, ethyl acrylate, propyl acrylate, butyl acrylate, 2-ethylhexyl acrylate, dimethylaminoethyl acrylate or the like; methacrylic acid ester such as methyl methacrylate, ethyl methacrylate, propyl methacrylate, butyl methacrylate, 2-ethylhexyl methacrylate, dimethylaminoethyl methacrylate or the like, an amide compound such as acrylamide, methacrylamide or the like; olefin such as ethylene, propylene, butylene or the like; and so on. The monovinyl monomers may be used alone or in combination. Among them, the styrene, the styrene derivative, the acrylic acid derivative or the methacrylic acid derivative is suitably used as the monovinyl monomer.

In the present invention, the monovinyl monomer may be preferably used in the ratio of at least 80% by weight or more of the polymerizable monomer for core constituting the binder resin.

In order to prevent hot offset, as a part of the polymerizable monomer for core, any crosslinkable polymerizable monomer may be preferably used together with the monovinyl monomer. The crosslinkable polymerizable monomer means a monomer having two or more polymerizable functional groups. As the crosslinkable polymerizable monomer, for example, there may be an aromatic divinyl compound such as divinyl benzene, divinyl naphthalene, a derivative thereof or the like; an unsaturated carboxylic acid polyester of polyalcohol such as ethylene glycol dimethacrylate, diethylene glycol dimethacrylate or the like; other divinyl compound such as N,N-divinylaniline, divinyl ether or the like; a compound containing three or more vinyl groups such as trimethylolpropane trimethacrylate, dimethylolpropane tetraacrylate or the like. The crosslinkable polymerizable monomers may be used alone or in combination of two or more kinds.

In the present invention, it is desirable that the ratio of the crosslinkable polymerizable monomer is generally from 0.1 to 5 parts by weight, preferably from 0.3 to 2 parts by weight, with respect to the monovinyl monomer of 100 parts by weight.

Also, it is preferable to use any macromonomer together with the monovinyl monomer as a part of the polymerizable monomer for core so that shelf stability and lowering of fixing temperature of a toner can be balanced. The macromonomer is a monomer having a polymerizable carbon-carbon unsaturated double bond at the end of a molecular chain, which is a reactive oligomer or polymer generally having a number average molecular weight from 1,000 to 30,000. As the macromonomer, a macromonomer which forms a polymer having higher Tg than that of a polymer obtained by polymerizing the monovinyl monomer is preferable.

In the present invention, it is desirable that the amount of the macromonomer is generally from 0.01 to 10 parts by weight, preferably from 0.03 to 5 parts by weight, more preferably from 0.05 to 1 part by weight, with respect to the monovinyl monomer of 100 parts by weight.

In the present invention, a colorant may be used. In the case of producing a colored toner, wherein there may be generally used four kinds of toners including a black toner, a cyan toner, a yellow toner and a magenta toner, a black, cyan, yellow or magenta colorant may be respectively used.

In the present invention, as the black colorant, there may be used a colorant such as carbon black, titanium black, a magnetic particle including zinc-ferric oxide, nickel-ferric oxide or the like.

As the cyan colorant, for example, a copper phthalocyanine compound, a derivative thereof, an anthraquinone compound or the like may be utilized. Specifically, there may be C. I. Pigment Blue 2, 3, 6, 15, 15:1, 15:2, 15:3, 15:4, 16, 17:1, 60 or the like. Since stability upon polymerizing the polymerizable monomer is excellent and tinting strength is sufficient, a copper phthalocyanine compound of C. I. Pigment Blue 15, 15:1, 15:2, 15.3, 15:4, 17:1 or the like is preferable, more preferably the copper phthalocyanine compound of C. I. Pigment Blue 15:3.

As the yellow colorant, for example, a compound such as an azo based pigment including a monoazo pigment, a disazo pigment or the like, a condensation polycyclic pigment or the like may be used. Specifically, there may be C.I. Pigment Yellow 3, 12, 13, 14, 15, 17, 62, 65, 73, 74, 83, 93, 97, 120, 138, 155, 180, 181, 185, 186 or the like.

As the magenta colorant, for example, a compound such as an azo based pigment including a monoazo pigment, a disazo pigment or the like, a condensation polycyclic pigment or the like may be used. Specifically, there may be C. I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, and 251, C.I. Pigment Violet 19 or the like. Similarly, since stability upon polymerizing the polymerizable monomer is excellent and tinting strength is sufficient, the monoazo pigment of C. I. Pigment Red 31, 48, 57:1, 58, 60, 63, 64, 68, 112, 114, 146, 150, 163, 170, 185, 187, 206, 207 or the like is preferable.

In the present invention, it is desirable that the amount of each colorant is preferably from 1 to 10 parts by weight, with respect to the polymerizable monomer for core of 100 parts by weight.

As other additives, a charge control agent is preferably used. As the charge control agent, various kinds of positive charge control agents or negative charge control agents may be used. For example, there may be a charge control agent which is not a resin such as a metallic complex of an organic compound having a carboxyl group or nitrogen-containing group, a metallized dye, nigrosine or the like; a charge control resin such as a quaternary ammonium base-containing copolymer, a sulfonic acid group- or sulfonic acid base-containing copolymer, a carboxyl group- or carboxylic acid base-containing copolymer or the like. Among them, since printing durability of the toner becomes excellent, the charge control agent containing the charge control resin is preferable. Among the charge control agents, the charge control agent which is not a resin and the charge control resin may be used together, or the charge control resin may be used alone. It is more preferable to use the charge control resin alone. It is further preferable to use the quaternary ammonium base-containing copolymer as the charge control resin.

In the present invention, it is desirable that the amount of the charge control agent is generally from 0.01 to 10 parts by weight, preferably from 0.03 to 8 parts by weight, with respect to the polymerizable monomer for core of 100 parts by weight.

As other additives, it is preferable to add a release agent since releasing characteristic of a toner from a fixing roller upon fixing can be improved. There is no particular limitation to the release agent as far as a generally used release agent for a toner is used. For example, there may be a low-molecular-weight polyolefin wax such as low-molecular-weight polyethylene, low-molecular-weight polypropylene, low-molecular-weight polybutylene or the like; a natural wax such as candelilla, a carnauba wax, a rice wax, a haze wax, jojoba or the like; a petroleum wax such as paraffin, microcrystalline, petrolactam or the like; a mineral wax such as montan, ceresin, ozokerite or the like; a synthesized wax such as a Fischer-Tropsch wax or the like; an esterified compound such as behenyl behenate, stearyl stearate, pentaerythritol ester, dipentaerythritol ester or the like; and so on.

In the present invention, it is desirable that the amount of the release agent is generally from 0.1 to 30 parts by weight, preferably from 1 to 20 parts by weight, with respect to the polymerizable monomer for core of 100 parts by weight.

As other additives, a molecular weight modifier may be preferably used. As the molecular weight modifier, for example, there may be mercaptans such as t-dodecyl mercaptan, n-dodecyl mercaptan, n-octyl mercaptan, 2,2,4,6,6-pentamethylheptane-4-thiol or the like. The molecular weight modifier may be added prior to initiating polymerization or during polymerization.

In the present invention, it is desirable that the amount of the molecular weight modifier may be generally from 0.01 to 10 parts by weight, preferably from 0.1 to 5 parts by weight, with respect to the polymerizable monomer for core of 100 parts by weight.

2. Suspension process (A) to obtain a suspension (process of forming droplets of polymerizable monomer composition for core)

Next, a polymerizable monomer composition for core obtainable as above is suspended in an aqueous dispersion medium containing a dispersion stabilizer, and thus a suspension having droplets of the polymerizable monomer composition for core dispersed is obtained.

A method of forming the droplets may not be particularly limited. Since the diameter of a toner depends mostly on the diameter of droplets of a suspension of the suspension process (A), namely, on the diameter of droplets of the polymerizable monomer composition for core in an aqueous dispersion medium, it is preferable to form uniform droplets having a small particle diameter and a spherical, desired shape. To form such droplets, for example, the polymerizable monomer composition for core is charged into an aqueous dispersion medium containing a dispersion stabilizer, followed by stirring. After adding a polymerization initiator further, mechanically the mixture is subject to high shear stirring by means of a device capable of strong stirring such as an in-line type emulsifying and dispersing machine (product name: EBARA MILDER; manufactured by: Ebara Corporation), a high-speed emulsifying and dispersing machine (product name: T. K. HOMOMIXER MARK II: manufactured by: PRIMIX Corporation) or the like so as to form droplets of the polymerizable monomer composition for core.

The aqueous medium dispersion used in the present invention may be solely water, but may be water with a water-soluble solvent. As the water-soluble solvent, for example, there may be lower alcohol such as methanol, ethanol, isopropanol or the like; dimethylformamide; tetrahydrofuran; low-molecular ketones such as acetone, methyl ethyl ketone or the like. An amount of the aqueous dispersion medium is preferably from 50 to 1,000 parts by weight, more preferably from 100 to 500 parts by weight, particularly preferable from 150 to 400 parts by weight, with respect to the polymerizable monomer for core of 100 parts by weight.

In the present invention, a dispersion stabilizer is contained in the aqueous dispersion medium. As the dispersion stabilizer, for example, there may be a hardly water-soluble inorganic compound soluble in acid or alkali such as sulfate including barium sulfate, calcium sulfate or the like; carbonate including barium carbonate, calcium carbonate, magnesium carbonate or the like; phosphate including calcium phosphate or the like; metal oxide including aluminum oxide, titanium oxide or the like; metal hydroxide including aluminum hydroxide, magnesium hydroxide, ferric hydroxide or the like; and so on. As the dispersion stabilizer, there may be also an organic compound such as a water-soluble polymer including polyvinyl alcohol, methyl cellulose, gelatin or the like; an anionic surfactant; a nonionic surfactant; an ampholytic surfactant; and so on.

Among the dispersion stabilizers, a colloid of the hardly water-soluble inorganic compound is preferably used since the particle size distribution of a toner can be narrowed. The colloid of the hardly water-soluble inorganic compound is obtained by mixing an aqueous solution of a polyvalent metal salt with an aqueous solution of a monovalent metal compound. Also, the colloid of the hardly water-soluble inorganic compound may be prepared by allowing an aqueous solution of one of the polyvalent metal salt and the monovalent metal compound to contact with a solid substance of the other.

As the polyvalent metal salt, there may be a halide salt, sulfate, nitrate or acetate with magnesium, aluminum, calcium, manganese, iron, nickel, copper, tin or the like. Among them, the salt of magnesium, aluminum or calcium is preferable. More specifically, as the salt of magnesium, there may be magnesium chloride, magnesium sulfate, magnesium nitrate, magnesium acetate, the hydrate thereof or the like. As the salt of aluminum, there may be aluminum chloride, aluminum sulfate, aluminum nitrate, aluminum acetate, the hydrate thereof or the like. As the salt of calcium, there may be calcium chloride, calcium sulfate, calcium nitrate, calcium acetate, the hydrate thereof or the like.

The polyvalent metal salts may be used alone or in combination of two or more kinds.

On the other hand, as the monovalent metal compound, there may be a salt or hydroxide of a negative ion selected from a phosphate ion, a hydrogen phosphate ion, a carbonate ion and a hydroxide ion with a monovalent metal.

As the monovalent metal of the monovalent metal compound, one or more kinds of monovalent metal selected from a group consisting of lithium, sodium and potassium is preferable. As the monovalent metal, more specifically, there may be hydroxide such as lithium hydroxide, sodium hydroxide, potassium hydroxide or the like; phosphate such as lithium phosphate, sodium phosphate, potassium phosphate or the like; carbonate such as lithium carbonate, sodium carbonate, potassium carbonate or the like; and so on. Among them, hydroxide is preferable.

The monovalent metal compounds may be used alone or in combination of two or more kinds.

The dispersion stabilizers may be used alone or in combination of two or more kinds. An added amount of the dispersion stabilizer is preferably from 0.1 to 20 parts by weight, more preferably from 0.2 to 10 parts by weight, with respect to the polymerizable monomer for core of 100 parts by weight.

Also, with respect to the aqueous dispersion medium of 100 parts by weight, the amount of the dispersion stabilizer is preferably from 0.1 to 10 parts by weight, more preferably from 0.2 to 5 parts by weight.

In the aqueous dispersion medium containing the polymerizable monomer composition for core and the dispersion stabilizer, a polymerization initiator is generally contained. The polymerization initiator added to the aqueous dispersion medium dissolves into the droplets of the polymerizable monomer composition for core. As the polymerization initiator, for example, there may be persulfate such as potassium persulfate, ammonium persulfate or the like; an azo compound such as 4,4′-azobis(4-cyanovaleric acid), 2,2′-azobis(2-methyl-N-(2-hydroxyethyl)propionamide, 2,2′-azobis(2-amidinopropane)dihydrochloride, 2,2′-azobis(2,4-dimethylvaleronitrile), 2,2′-azobisisobutyronitrile or the like; organic peroxides such as di-t-butylperoxide, benzoylperoxide, t-butylperoxy-2-ethylhexanoate, t-hexylporoxy-2-ethylhexanoate, t-butylperoxypyvalate, diisopropylperoxydicarbonate, di-t-butylperoxyisophthalate, t-butylperoxyisobutyrate or the like. Also, a redox initiator which is a combination of the polymerization initiator and a reducing agent may be used. Among the above, the organic peroxides may be preferably used since a residue amount of the polymerizable monomer for core can be held down and printing durability is good.

An added amount of the polymerization initiator used for polymerization of the polymerizable monomer composition for core may be preferably from 0.1 to 20 parts by weight, more preferably from 0.3 to 15 parts by weight, most preferably from 1.0 to 10 parts by weight, with respect to the polymerizable monomer for core of 100 parts by weight.

3. Core Particle Forming Process (B) (Polymerization Process of Droplets of Polymerizable Monomer Composition for Core)

Next, the temperature of the suspension having droplets of the polymerizable monomer composition for core dispersed as obtained above is raised in the presence of the polymerization initiator followed by suspension polymerization, and thus a core particle dispersion liquid in which core particles (toner particles) containing the binder resin and the colorant is formed and dispersed in the aqueous dispersion medium is obtained.

A method of suspension polymerization is not particularly limited. In order to raise the temperature for suspension polymerization in the presence of the polymerization initiator keeping droplets of the polymerizable monomer composition for core stable, it is preferable that after the process (A) to obtain the suspension (a process of forming droplets of the polymerizable monomer composition for core), a suspension polymerization reaction follows along with dispersion treatment by agitation. To perform such suspension polymerization, for example, a suspension having droplets of the polymerizable monomer composition for core dispersed is charged into a reactor furnished with stirring vanes, the temperature of the reactor is raised in the presence of the polymerization initiator, and polymerization reaction is continued wile stirring until the polymerization conversion rate reaches almost 100%. As the result, core particles are formed.

A polymerization temperature in the core particle forming process (B) is preferably 50° C. or more, more preferably from 60 to 95° C. In the present invention, a polymerization reaction time in the core particle forming process (B) is preferably from 1 to 20 hours, more preferably from 2 to 10 hours.

4. Shell Layer Forming Process (C)

Next, polymerizable monomers for shell are added to the core particle dispersion liquid in which the core particles are dispersed in the aqueous dispersion medium as obtained above followed by polymerization in the presence of the polymerization initiator so as to cover the core particle with a shell layer, thus an aqueous dispersion of toner particles having a core-shell type structure is obtained.

Each of the toner particles having a core-shell type structure of the present invention constitutes of an inside core particle containing a binder resin comprising a polymer having a low-softening point covered with an outside shell layer comprising a polymer having a glass transition temperature from 70 to 120° C. so that the toner can be balanced between shelf stability and fixing ability at low temperature.

The glass transition temperature (Tg) of the polymer (the binder resin) constituting the core particle of the present invention is preferably from 30 to 65° C., more preferably from 40 to 60° C. The glass transition temperature (Tg) of the polymer (the binder resin) constituting the shell layer is preferably from 80 to 110° C., more preferably from 90 to 110° C. The glass transition temperature (Tg) of the polymer constituting the shell layer needs to be higher than that of the polymer constituting the core particle.

As a method of forming the shell layer, an in situ polymerization method is preferably employed from the viewpoint of production efficiency. Hereinafter, a production method of toner particles having a core-shell type structure by the in situ polymerization method will be described.

In the core particle dispersion liquid having the core particles obtained in the process (B) dispersed in the aqueous dispersion medium, at least a polymerizable tertiary amino compound having the structure represented by the following Chemical formula 1 is added as one of the polymerizable monomers for shell. Further, a polymerization initiator for shell is added followed by polymerization in the presence of the polymerization initiator for shell, thus obtained toner particles having a core-shell type structure.

In the present invention, as the polymerizable monomer for shell, the polymerizable tertiary amino compound having the structure represented by the following Chemical formula 1 is used: 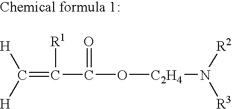
wherein, R¹, R² and R³ independently represent hydrogen or an alkyl group having 1 to 4 carbon atoms respectively.

There is no particular limitation to the polymerizable tertiary amino compound having the structure represented by the following Chemical formula 1 as far as it satisfies the above structure. R¹, R² and R³ in the above formula are independently hydrogen or an alkyl group having 1 to 4 carbon atoms respectively, namely, a substituent selected from the group consisting of a hydrogen atom, a methyl group, an ethyl group, an n-propyl group, an i-propyl group, an n-butyl group, an i-butyl group, a s-butyl group, and a t-butyl group. Among them, R² and R³ are independently preferable to be an alkyl group having 2 or 3 carbon atoms respectively, namely, an ethyl group, an n-propyl group or an i-propyl group.

Specific examples of the polymerizable tertiary amino compound having the structure represented by the above Chemical formula 1 used in the present invention include dimethylaminoethyl methacrylate, ethylmethylaminoethyl methacrylate, n-propyl methylaminoethyl methacrylate, i-propyl methylaminoethyl methacrylate, n-butyl methylaminoethyl methacrylate, i-butyl methylaminoethyl methacrylate, s-butyl methylaminoethyl methacrylate, t-butyl methylaminoethyl methacrylate, diethylaminoethyl methacrylate, ethyl n-propyl aminoethyl methacrylate, ethyl i-propyl aminoethyl methacrylate, ethyl n-butyl aminoethyl methacrylate, ethyl i-butyl aminoethyl methacrylate, ethyl s-butyl aminoethyl methacrylate, ethyl t-butyl aminoethyl methacrylate, di-n-propyl aminoethyl methacrylate, di-i-propyl aminoethyl methacrylate, n-propyl i-propyl aminoethyl methacrylate, n-butyl n-propyl aminoethyl methacrylate, di-n-butyl aminoethyl methacrylate or the like.

Among them, diethylaminoethyl methacrylate, ethyl n-propyl aminoethyl methacrylate, ethyl i-propyl aminoethyl methacrylate, di-n-propyl aminoethyl methacrylate, di-i-propyl aminoethyl methacrylate or the like is preferably used, and diethylaminoethyl methacrylate is particularly preferable.

The shell layer of the toner particles having a core-shell type structure of the present invention needs to contain a polymer having a repeating unit derived from the polymerizable tertiary amino compound having the structure represented by the above chemical formula 1. The polymer is preferably used together with the above-mentioned monovinyl monomer which is a main component of the polymerizable monomer for core to form the shell layer.

An added amount of the polymerizable monomers for shell containing at least one kind selected from the group consisting of the above-mentioned polymerizable tertiary amino compound having the structure represented by the above Chemical formula 1 is in the range from 0.1 to 10 parts by weight, preferably from 0.3 to 6 parts by weight, with respect to the polymerizable monomer for core of 100 parts by weight.

When the added amount of the polymerizable monomers for shell used in the present invention is in the above range, it is able to obtain a non-magnetic one-component toner for developing an electrostatic image which is well-balanced between shelf stability and fixing ability at low temperature and further, from the viewpoint of charge property, a good initial charge speed is performed and fogs are hardly produced in the early stage of printing along with a stable appropriate charge property so that printing durability is excellent hardly causing fogs even after continuous printing of plural images.

On the other hand, if the added amount of the polymerizable monomers for shell is less than the above range, shelf stability may decrease. If the added amount exceeds the above range, fixing ability at low temperature may decrease.

It is preferable that a quantitative relationship between an amount “X” of the polymerizable tertiary amino compound having the structure represented by the above Chemical formula 1 and an amount “Y” of the other polymerizable monomer both contained in the polymerizable monomers for shell of the present invention fulfills the following Calculation formula 1:
0.05<(X/Y)<1.0 Calculation formula 1:

If the quantitative relationship between the amount “X” of the polymerizable tertiary amino compound and the amount “Y” of the other polymerizable monomer is less than the range of the Calculation formula 1, fogs may be produced in the early stage of printing. On the contrary, when the quantitative relationship between the amounts “X” and “Y” exceeds the range of the Calculation formula 1, shelf stability may decrease.

As the polymerization initiator used for polymerization of the polymerizable monomers for shell, there may be a water-soluble polymerization initiator such as a persulfate including potassium persulfate, ammonium persulfate or the like; an azo compound including 2,2′-azobis(2-methyl-N-(2-hydroxyethyl)propionamide), 2,2′-azobis-(2-methyl-N-(1,1-bis(hydroxymethyl) 2-hydroxyethyl)propionamide) or the like; and so on.

An added amount of the polymerization initiator may be preferably from 0.1 to 30 parts by weight, more preferably from 1 to 20 parts by weight, with respect to the polymerizable monomers for shell of 100 parts by weight.

A polymerization temperature in the shell layer forming process (C) may be preferably 50° C. or more, more preferably from 60 to 95° C. Also, in the present invention, a polymerization reaction time in the shell layer forming process may be preferably from 0.1 to 10 hours, more preferably from 0.5 to 5 hours.

A thickness of the shell layer of the toner particles having a core-shell type structure of the present invention may be preferably from 5 to 150 nm, more preferably from 10 to 120 nm, still more preferably from 20 to 80 nm, still further preferably from 30 to 60 nm.

If the thickness of the shell layer of the toner particles having a core-shell type structure of the present invention is less than the above range, shelf stability may decrease. On the contrary, if it exceeds the above ranger fixing ability at low temperature may decrease.

Provided that the polymerizable monomer for core has the same specific gravity as the polymerizable monomers for shell, the thickness of the shell layer of the toner particles having a core-shell type structure can be calculated from an added amount of the polymerizable monomer for core, an added amount of the polymerizable monomers for shell and a volume average particle diameter “Dv” of the toner particles having a core-shell type structure, by using the following Calculation formula 2:

$${( \frac{( \begin{matrix}\begin{matrix}Added amount of \\ polymerizable \\ monomer for core \end{matrix} \\ ( parts by weight )\end{matrix} ) + ( \begin{matrix}Added amount of \\ polymerizable \\ monomer for shell \\ ( parts by weight )\end{matrix} )}{\begin{matrix}Added amount of polymerizable \\ monomer \\ for core ( parts by weight )\end{matrix}} )}^{\frac{1}{3}} = \frac{\begin{matrix}Volume average particle diameter \\ “ Dv ” of toner particle having \\ core \text{-} shell type structure\end{matrix}}{( \begin{matrix}Volume average particle \\ diameter “ Dv ” of toner \\ particle having core \text{-} shell \\ type structure\end{matrix} ) - ( \begin{matrix}Thickness of \\ shell layer\end{matrix} ) \times 2} \qquad Calculation formula 2$$

In the Calculation formula 2, the added amount of the polymerizable monomer for core means a total amount of all polymerizable monomers constituting a core particle including a monovinyl monomer, a crosslinkable polymerizable monomer, a macromonomer and so on. The added amount of the polymerizable monomers for shell means a grand total amount “X+Y” of the amount “X” of the polymerizable tertiary amino compound having the structure represented by the above Chemical formula 1 and the amount “Y” of the other polymerizable monomer contained in the polymerizable monomers for shell, each of which constitutes the shell layer.

In the present inventions the shell layer forming process (C) is preferably performed in two stages. As the polymerizable monomers for forming the shell layer (the second layer) in the second stage, the above-mentioned polymerizable tertiary amino compound of the Chemical formula 1 is preferably used. In the process, it is preferable to adjust a glass transition temperature of the shell layer (the second layer) to be formed in the second stage lower than that of the shell layer (the first layer) to be formed in the first stage though a glass transition temperature of the whole shell layers is set in the above-mentioned range of from 70 to 120° C. The glass transition temperature of the shell layer to be formed in the first stage may be preferably from 90 to 120° C., more preferably from 95 to 110° C. The glass transition temperature of the shell layer to be formed in the second stage may be preferably from 70 to 100° C., more preferably from 75 to 95° C.

By adjusting the glass transition temperature of the shell layer to be formed in the second stage lower than that of the shell layer to be formed in the first stage, fixing ability at low temperature and shelf stability can be well-balanced.

In the present invention, a ratio of the shell layer to be formed in the first stage and the shell layer to be formed in the second stage may be preferably from 10:90 to 90:10, more preferably from 20:80 to 8.0.20,

5. Filtering, Washing, Dewatering and Drying

The aqueous dispersion of the toner particles having a core-shell type structure obtained in the shell layer forming process as mentioned above is preferably subject to filtering, washing (removal of the dispersion stabilizer), dewatering and drying for several times, if necessary, in conventional manner.

In the aqueous dispersion of the toner particles having a core-shell type structure, if an acid-soluble, hardly water-soluble inorganic compound is used as the dispersion stabilizer, acid is added to the aqueous dispersion so as to dissolve the dispersion stabilizer in water and remove. On the other hand, if an alkali-soluble, hardly water-soluble inorganic compound is used as the dispersion stabilizer, alkali is added in place of acid.

For example, if the acid-soluble dispersion stabilizer is used, it is preferable to add acid so as to adjust pH of the aqueous dispersion of the toner particles having a core-shell type structure to 6.5 or less. It is more preferable to add acid so as to adjust pH to 6 or less. As the acid to be added, there may be inorganic acid such as sulfuric acid, hydrochloric acid, nitric acid or the like, and organic acid such as formic acid, acetic acid or the like. Sulfuric acid is particularly suitable as removing efficiency is high and adverse affect on production facilities is small.

6. Toner particles having core-shell type structure

After the above-mentioned processes, it is able to obtain toner particles having a core-shell type structure wherein the core particle containing at least the first binder resin and a colorant is covered with the shell layers containing a polymer having a repeating unit derived from the polymerizable tertiary amino compound having a structure represented by the following Chemical Formula 1 as the second binder resin: 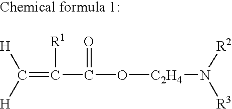
wherein, R¹, R² and R³ independently represent hydrogen or an alkyl group having 1 to 4 carbon atoms respectively.
7. Non-Magnetic One-Component Toner for Developing Electrostatic Image

Generally, toners are broadly classified into a magnetic toner and a non-magnetic toner according to whether toner particles contain a magnetic powder or not. Further, toners are broadly classified into a one-component toner using only toner and a two-component toner using toner and carrier. Among them, the one-component non-magnetic toner can be used as a colored toner which can perform high speed printing and provide high resolution and reproduction of a clear color tone since it does not contain a magnetic powder of dark color.

The non-magnetic one-component toner for developing an electrostatic image having a core-shell type structure obtained by the production method of the present invention is a non-magnetic one-component toner for developing an electrostatic image prepared in such a manner that toner particles having a core-shell type structure and an additive are mixed by means of a high-speed agitator such as HENSCHEL MIXER (product name; manufactured by: Mitsui Mining Co., Ltd.) or the like in order to adjust a charge property, flowability, shelf stability and so on.

As the external additive, there may be inorganic microparticles of silica, titanium oxide, aluminum oxide, zinc oxide, tin oxide, calcium carbonate, calcium phosphate, cerium oxide or the like; and organic microparticles of a polymethyl methacrylate resin, a silicone resin, a melamine resin or the like. Among them, the inorganic microparticles are preferable, silica and titanium oxide are more preferable, and silica is still more preferable.

An added amount of the external additive is generally from 0.1 to 6 parts by weight, preferably from 0.2 to 5 parts by weight, with respect to the toner particles having a core-shell type structure of 100 parts by weight. As the external additive, two or more kinds of microparticles may be preferably used in combination.

As for the non-magnetic one-component toner for developing an electrostatic image having a core-shell type structure obtained by the production method of the present invention, under environment at a temperature of 23° C. and a relative humidity of 50%, a charge amount “Q/M” per unit weight of the toner on a surface of a developing roller of an image forming device is preferably in the range from 20 to 80 μC/g, more preferably from 25 to 70 μC/g.

The charge amount “Q/M” per unit weight of a toner can be obtained by dividing a total charge amount “Q” of the toner by a weight “M” of the toner subject to measurement.

The charge amount of the toner on the surface of the developing roller can be obtained by measuring the charge amount of the toner developed on the developing roller after solid pattern printing of the first page is performed with a printer, followed by stopping solid pattern printing of the second page halfway by means of, for example, a suction type Q/m analyzer (product name: 210HS-2A; manufactured by: Trek Japan KK.).

If the charge amount “Q/M” per unit weight of the toner is less than the above range, fogs may be liable to occur in the early stage of printing since an appropriate charge property cannot be obtained so that an initial charge speed is not good. In contrast, if the charge amount “Q/M” exceeds the above range, fogs or toner filming may occur in continuous printing since the toner is overcharged so that the toner is liable to remain on a photosensitive member upon transferring.

A volume average particle diameter “Dv” of the non-magnetic one-component toner for developing an electrostatic image having a core-shell type structure obtained by the production method of the present invention may be preferably from 3 to 15 μm, more preferably from 4 to 12 μm. If “Dv” is less than the above range, toner flowability decreases so that toner transferability may decrease, a blur may occur, or image density may decrease. If “Dv” exceeds the above range, resolution of an image may decrease.

A number-based percentage of the toner particles with a particle diameter of 5 μm or less is preferably 25% or less, more preferably 18% or less. If the number-based percentage of the toner particles having a core-shell type structure and a small particle diameter of 5 μm or less exceeds the above range, flowability of the toner to be obtained decreases so that transferability may deteriorate, and thus a blur may be liable to occur in a printed product or image density may be liable to decrease.

A ratio “Dv/Dp” of the volume average particle diameter “Dv” and a number average particle diameter “Dp” of the non-magnetic one-component toner for developing an electrostatic image having a core-shell type structure obtained by the production method of the present invention is preferably from 1.0 to 1.3, more preferably from 1.0 to 1.2. If “Dv/Dp” exceeds the above range, a blur may occur or a decrease in transferability, image density or resolution may occur. The volume average particle diameter and the number average particle diameter of the toner having a core-shell type structure can be measured, for example, by means of MULTISIZER (product name; manufactured by: Beckman Coulter, Inc.).

In the present invention, the circularity is a value obtained by dividing a perimeter of a circle having the same area as a projected image of a particle by a perimeter of the projected image of the particle. Also, the average circularity of the present invention is used as a simple method of presenting a shape of a particle quantitatively and is an indicator showing the level of convexo-concave shapes of the toner particles having a core-shell type structure. The average circularity is “1” when the toner particles are an absolute sphere, and becomes smaller as the shape of the surface of the toner particles becomes more complex.

In order to obtain the average circularity ‘Ca’, firstly, circularity “Ci” of each of measured “n” particles having 0.4 μm or more diameter equivalent circle is calculated by the following Calculation formula 3. Next, the average circularity “Ca” is obtained by the following Calculation formula 4.
circularity “Ci”=a perimeter of a circle having the same area as a projected area of a particle/a perimeter of the projected image of the particle Calculation Formula 3:

$$C a = \frac{{\sum }_{i = 1}^{n} ( C i \times f i )}{{\sum }_{i = 1}^{n} ( f i )} \qquad Calculation formula 4$$

In Calculation formula 4, “fi” is the frequency of a particle of the circularity “Ci”.

The above circularity and average circularity are measured by means of a flow particle image analyzer (product names: FPIA-2000, PPIA-2100 and FPIA-3000; manufactured by: Sysmex Co.) or the like.

The non-magnetic one-component toner for developing an electrostatic image of the present invention produced through the above-mentioned processes is well-balanced between shelf stability and fixing ability at low temperature, thus, it can satisfy the demand for saving energy consumed by an image forming device and high-speed image printing. By using the non-magnetic one-component toner for developing an electrostatic image obtained by the production method of the present invention for printing, an initial charge speed of the toner is good and fogs are hardly produced in the early stage of printing since the toner has an appropriate charge property. Also, due to a stable, appropriate charge property, printing durability is excellent from the viewpoint of hardly producing fogs in the early stage of printing even after continuous printing of plural images, and high quality images can be formed.

### EXAMPLES

Hereinafter, the present invention will be explained further in detail with reference to examples and comparative examples. However, the scope of the present invention may not be limited to the following examples. Herein, “part(s)” and “%” are based on weight if not particularly mentioned.

Test methods used in the examples and the comparative examples are as follows

(1) Measurement of Glass Transition Temperature

About 10 mg of test sample was weighed and, in accordance with ASTM D3418-97 using a Differential Scanning Calorimetry (product name: SSC5200; manufactured by: Seiko Instruments, Inc.) charged into an aluminum pan. Measurement of the glass transition temperature (Tg) of each of a polymer (binder resin) constituting a core particle and a polymer (binder resin), constituting a shell layer was performed using an empty aluminum pan as a reference under the condition of the temperature in the range from room temperature to 150° C. and a heating rate of 10° C./min.

(2) Measurement of Particle Diameter

(2-1) Measurement of Volume Average Particle Diameter “Dv” and Particle Size Distribution “Dv/Dp”

The volume average particle diameter “Dv” and the number average particle diameter “Dp” of the toner were measured by means of a particle diameter measuring device (product name: MULTISIZER; manufactured by: Beckman Coulter, Inc.). Measurement by means of MULTISIZER was carried out under the condition of an aperture diameter of 100 μm, using ISOTON II as a medium, and a number of the measured particles of 100,000. More specifically, a toner of 0.1 g was charged into a beaker adding an aqueous solution of alkyl benzene sulfonate (product name: DRIWEL; manufactured by: Fujifilm Corporation) of 0.1 ml as a dispersing agent. Further, from 10 to 30 ml of ISOTON II was added to the beaker. The mixture was dispersed by means of a 20 W ultrasonic disperser for three minutes and was subject to measurement by means of the above particle diameter measuring device.

(2-2) Measurement of Average Circularity

Into a container pre-filled with ion-exchanged water of 10 ml, a surfactant (alkyl benzene sulfonate) of 0.02 g as a dispersing agent and a toner of 0.02 g were charged. Then, dispersion treatment was performed by means of an ultrasonic disperser at 60 watts for three minutes. The toner particle density during measurement was adjusted to be 3,000 to 10,000 particles/μL and 1,000 to 10,000 toner particles having a diameter of 0.4 μm or more by a diameter of the equivalent circle were subject to measurement by means of a flow particle image analyzer (product name: FPIA-1000; manufactured by: Sysmex Co.) The average circularity was calculated from measured values thus obtained.

Circularity can be calculated by the following Calculation formula 3, and the average circularity is an average of calculated circularities;
Circularity=a circumference of a circle having an area same as a projected area of a particle image/a perimeter of a particle image Calculation Formula 3:
(3) Thickness of Shell Layer

A thickness of the shell layer was calculated from a volume average particle diameter “Dv” of the toner measured with the particle diameter measuring device mentioned in the above (2), an added amount of the polymerizable monomers for core (monovinyl monomer: styrene, butyl acrylate; crosslinkable polymerizable monomer; divinylbenzene; macrormonomer: polymethacrylic acid ester macromonomer) and an added amount of the polymerizable monomers for shell (diethylaminoethyl methacrylate, methyl methacrylate), by using the following Calculation formula 2, in which it was assumed that the polymerizable monomer for core has the same specific gravity as the polymerizable monomers for shell:

$${( \frac{( \begin{matrix}\begin{matrix}Added amount of \\ polymerizable \\ monomer for core \end{matrix} \\ ( parts by weight )\end{matrix} ) + ( \begin{matrix}Added amount of \\ polymerizable \\ monomer for shell \\ ( parts by weight )\end{matrix} )}{\begin{matrix}Added amount of polymerizable \\ monomer \\ for core ( parts by weight )\end{matrix}} )}^{\frac{1}{3}} = \frac{\begin{matrix}Volume average particle diameter \\ “ Dv ” of toner particle having \\ core \text{-} shell type structure\end{matrix}}{( \begin{matrix}Volume average particle \\ diameter “ Dv ” of toner \\ particle having core \text{-} shell \\ type structure\end{matrix} ) - ( \begin{matrix}Thickness of \\ shell layer\end{matrix} ) \times 2} \qquad Calculation formula 2$$

(4) Measurement of Charge Amount “Q/M” Per Unit Weight of Toner on Surface of Developing Roller

A commercially available printer of a non-magnetic one-component developing method (printing speed: 22 prints in A4 size per minute) was charged with printing papers and inserted with a cartridge charged with a toner which was left under a NH (normal temperature and humidity) environment having a temperature of 23° C. and a humidity of 50% for one day, followed by printing under the NN environment having a temperature of 23° C. and a humidity of 50% for evaluation.

After solid pattern printing of the first page with 0% image density was performed with the printer followed by stopping solid pattern printing of the second page halfway, the charge amount per unit weight Q/M (μC/g) of the toner attached on the developing roller was measured by means of a suction type Q/m analyzer (product name: 210HS-2A; manufactured by; Trek Japan KK.).

(5) Shelf Stability

A hermetically-sealable container made of polyethylene and having a capacity of 100 ml was charged with the toner of 10 g, hermetically closed and sunk in a constant temperature water bath kept at 55° C. The container was removed from the bath after 15 hours. The toner thus stored was transferred from the container onto a 42 mesh screen gently and carefully so that an aggregation structure of the toner does not collapse. The screen was vibrated by means of a powder characteristics measuring device (product name. POWDER CHARACTERISTICS TESTER; manufactured by: Hosokawa Micron Corporation) at an amplitude of 1.0 mm for 30 seconds. A weight of the toner remained on the screen was measured and referred to as the weight of the aggregated toner.

A ratio (% by weight) of the weight of the aggregated toner with respect to the initial weight of the toner when charged into the container (weight of the toner before storing) was calculated. Measurement was performed three times on one sample, and an average value thereof was referred to as the indicator of shelf stability.

(6) Minimum Fixing Temperature (Fixing Ability at Low Temperature)

A fixing ability test was performed as follows by means of a commercially available printer of a non-magnetic one-component developing method (printing speed: 22 prints in A4 size per minute) which was modified so as to change the temperature of a fixing roller part Firstly, a solid pattern printing with 100% image density was printed. After changing the temperature of the fixing roller of the modified printer, a fixing rate of the toner at each temperature was measured to obtain a relation of temperature and fixing rate. The minimum fixing roller temperature having a fixing rate of more than 80% was regarded to as the minimum fixing temperature of the toner for evaluation.

The fixing rate was calculated from a ratio of image densities before and after peeling a tape attached on a solid pattern printing area having 100% image density More specifically, the fixing rate may be calculated by the following calculation formula 5, wherein “ID (before)” is an image density before peeling a tape and “ID (after)” is an image density after peeling tape:
Fixing rate (%)=(ID(after)/ID(before))×100 Calculation formula 5:

Herein, a tape peeling operation includes a series of operations of: attaching an adhesive tape (product name: SCOTCH MENDING TAPE 810-3-18; manufactured by: Sumitomo 3M Limited) on a measurement area of a printing test paper; applying constant pressure thereon to firmly attach the tape on the printing test paper; and peeling off the tape at a constant speed in the direction along the printing test paper surface. The image density was measured by means of a reflection image densitometer (product name: RD914; manufactured by: Macbeth Process Measurements Co.).

(7) Printing Test

(7-1) Printing Test in Early Stage of Printing

The printer used in “(4) Measurement of charge amount “Q/M” per unit weight of toner an surface of developing roller” was charged with printing papers and a cartridge charged with a toner which was left under the NN (normal temperature and humidity) environment for one day was mounted to measure an initial fog value as follows.

After solid pattern printing with 0% image density of the first page was performed with the printer followed by stopping solid pattern printing at the tenth page, the toner of a nonimage area remained on the photosensitive member after developing was attached to an adhesive tape (product name; SCOTCH MENDING TAPE 810-3-18; manufactured by: Sumitomo 3M Limited). The tape was attached to a new printing paper, and color tone was measured by means of a spectrophotometer (product name: SE-2000; manufactured by: NIPPON DENSHOKU INDUSTRIES CO., LTD.) As a reference (or a benchmark sample), an unused tape was attached to a printing paper so as to measure color tones in the same manner. Each color tone was referred as a coordinate of L*a*b* space, and color difference ΔE was calculated from the color tones of the sample for measurement and the benchmark sample. The color difference ΔE is called an initial fog value. As the initial fog value decreases, less fogs are produced in the early stage of printing. If the initial fog value ΔE is 1 or less, image quality is excellent.

(7-2) Continuous Printing Test

The printer used in “(4) Measurement of charge amount “Q/M” per unit weight of toner on surface of developing roller” was charged with printing papers and a toner was charged into a developing device of the printer. After the printer was left under the NN (normal temperature and density) environment for one day, continuous printing with 1% image density was performed. A solid patterned image with 0% image density was printed every 1,000 prints to measure a fog value in the same manner as “(7-1) Printing test in the early stage”. 10,000 prints were continuously printed to test how many prints with image quality having a fog value of 1.0 or less can be maintained when solid patterned images with 0% printing density were printed. “10,000<” in Table 1 means that this standard was met even after continuous printing of 10,000 prints.

### Example 1

Into a container, 70 parts of styrene as a monovinyl monomer, 15 parts of butyl acrylate and 5 parts of a cyan colorant (product name: FASTOGEN BLUE GCTF, C.I. Pigment Blue 15:3; manufactured by; Dainippon Ink & Chemicals, Inc.) were charged followed by preparatory dispersion using an in-line type emulsifying and dispersing machine (product name: MILDER; manufactured by: Ebara Corporation) as a preparatory dispersing machine at a rim speed of 23 m/s and 26 times of circulation frequency. A polymerizable monomer mixture for core thus obtained was subject to further dispersion by means of a media type dispersing machine (product name: PICa GRAIN MILL; manufactured by: Asada Iron Works. Co., Ltd.).

Next, to the polymerizable monomer mixture for core of 90 parts in which the cyan colorant was finely dispersed, 11 parts of styrene as a monovinyl monomer, 4 parts of butyl acrylate, 1.7 parts of a charge control resin having a positively charging ability (product name: 207P, constitutional repeating units comprising 2% of quaternary ammonium functional group; manufactured by: Fujikura Kasei Co., Ltd.) 0.5 part of polymethacrylic acid ester macromonomer (product name: AA6; manufactured by: Toagosei Co., Ltd.), 8 parts of dipentaerythritol hexamyristate as a release agent, 1.5 parts of t-dodecyl mercaptan as a molecular weight modifier and 0.5 part of divinylbenzene as a crosslinkable polymerizable monomer were added followed by stirring and dissolving, thus prepared a polymerizable monomer composition for core.

On the other hand, to an aqueous solution of 11.5 parts of magnesium chloride dispersed in 250 parts of ion-exchange water, an aqueous solution of 6.5 parts of sodium hydroxide dispersed in 50 parts of ion-exchange water was gradually added while stirring to prepare a magnesium hydroxide colloid dispersion liquid as an aqueous dispersion medium.

In the magnesium hydroxide colloid dispersion liquid thus obtained as an aqueous dispersion medium, the polymerizable monomer composition for core was poured and stirred. Thereafter, 5 parts of t-butylperoxy-2-ethylhexanoate (product name; PERBUTYL 0; manufactured by: NOF Corporation) was charged into the mixture as a polymerization initiator. A high shear stirring was performed thereon at 15,000 rpm for 10 minutes by means of an in-line type emulsifying and dispersing machine (product name; MILDER; manufactured by: Ebara Corporation) thus obtained a suspension having droplets of the polymerizable monomer composition for core dispersed.

The suspension having droplets of the polymerizable monomer composition for core dispersed was charged into a reactor furnished with stirring vanes. While stirring the suspension, the temperature of the reactor was raised to polymerize the suspension. With controlling the temperature to be constant at 90° C., polymerization reaction was continued for five hours so as to reach a polymerization conversion rate of almost 100%, thus obtained a dispersion liquid having core particles dispersed in the aqueous dispersion medium.

When the polymerization conversion rate of almost 100% was reached, at the same polymerization temperature, 1 part of methyl methacrylate as a polymerizable monomer for shell in the first stage was added to the above-obtained dispersion liquid having core particles dispersed in the aqueous dispersion medium. Then, as a polymerization initiator for shell, 0.35 part of 2,2′-azobis-(2-methyl-N-(1,1-bis(hydroxymethyl) 2-hydroxyethyl)propionamide) (product name; VA-086; manufactured by: Wako Pure Chemical Industries, Ltd.) dissolved in 35 parts of ion-exchanged water was added, and polymerization reaction was further continued at 90° C. for one hour.

Next, 0.5 part of diethylaminoethyl methacrylate and 2.5 parts of methyl methacrylate were added as polymerizable monomers for shell in the second stage. Then, as a polymerization initiator for shell, 0.35 part of 2,2′-azobis-(2-methyl-N-(1,1-bis(hydroxymethyl) 2-hydroxyethyl)propionamide) (product name; VA-086; manufactured by: Wako Pure Chemical Industries, Ltd.) dissolved in 35 parts of ion-exchanged water was added, and polymerization reaction was further continued for 3 hours and stopped at 90° C., thus obtained an aqueous dispersion of toner particles having a core-shell type structure and pH of 9.5.

While stirring the aqueous dispersion of toner particles thus obtained, sulfuric acid was added therein to make pH 6 or less as an acid washing. After the mixture was dewatered by filtration, new ion-exchanged water was added by 500 parts to make the mixture slurry again as a water washing. Dewatering and water washing were then repeated for several times. After separating solid content by filtration, the solid content was dried by a drier at 40° C. for two days and nights, thus obtained toner particles having a core-shell type structure.

To the toner particles having a core-shell type structure thus obtained of 100 parts, 1 part of silica having a volume average particle diameter of 12 nm and 1.5 parts of silica having a volume average particle diameter of 40 nm were added and mixed by means of HENSCHEL MIXER (product name) at 1,400 rpm for 10 minutes, thus produced a toner of Example 1.

### Examples 2 and 3

Toners of Examples 2 and 3 were produced in the same condition as in Example 1 except that added amounts of the polymerizable monomers for shell were changed as mentioned in Table 1.

### Example 4

Into a container, 70 parts of styrene as a monovinyl monomer, 15 parts of butyl acrylate and 5 parts of a cyan colorant (product name: FASTOGEN BLUE GCTF, C.I. Pigment Blue 15±3; manufactured by: Dainippon Ink & Chemicals, Inc.) were charged followed by preparatory dispersion using an in-line type emulsifying and dispersing machine (product name: MILDER; manufactured by; Ebara Corporation) as a preparatory dispersing machine at a rim speed of 23 m/s and 26 times of circulation frequency A polymerizable monomer mixture for core thus obtained was subject to further dispersion by means of a media type dispersing machine (product name; PTCO GRAIN MILL; manufactured by: Asada Iron Works. Co., Ltd.).

Next, to the polymerizable monomer mixture for core of 90 parts in which the cyan colorant was finely dispersed, 11 parts of styrene as a monovinyl monomer, 4 parts of butyl acrylate, 1.7 parts of a charge control resin having a positively charging ability (product name: 2072, constitutional repeating units comprising 2 of quaternary ammonium functional group; manufactured by: Fujikura Kasei Co., Ltd.), 0.5 part of polymethacrylic acid ester macromonomer (product name: AA6; manufactured by: Toagosei Co., Ltd.), 8 parts of dipentaerythritol hexamyristate as a release agent, 1.5 parts of t-dodecyl mercaptan as a molecular weight modifier and 0.5 part of divinylbenzene as a crosslinkable polymerizable monomer were added, followed by stirring and dissolving, thus prepared a polymerizable monomer composition for core.

On the other hand, to an aqueous solution of 11.5 parts of magnesium chloride dispersed in 250 parts of ion-exchange water, an aqueous solution of 6.5 parts of sodium hydroxide dispersed in 50 parts of ion-exchange water was gradually added while stirring to prepare a magnesium hydroxide colloid dispersion liquid as an aqueous dispersion medium.

In the magnesium hydroxide colloid dispersion liquid thus obtained as an aqueous dispersion medium, the polymerizable monomer composition for core was poured and stirred. Thereafter, 5 parts of t-butylperoxy-2-ethylhexanoate (product name: PERBUTYL 0; manufactured by: NOF Corporation) was charged into the mixture as a polymerization initiator. A high shear stirring was performed thereto at 15,000 rpm for 10 minutes by means of an incline type emulsifying and dispersing machine (product name: MILDER; manufactured by: Ebara Corporation), thus obtained a suspension having droplets of the polymerizable monomer composition for core dispersed.

The suspension having droplets of the polymerizable monomer composition for core dispersed was charged into a reactor furnished with stirring vanes. While stirring the suspension, the temperature of the reactor was raised to polymerize the suspension. With controlling the temperature to be constant at 90° C., polymerization reaction was continued for five hours so as to reach a polymerization conversion rate of almost 100%, thus obtained a dispersion liquid having core particles dispersed in the aqueous dispersion medium.

When the polymerization conversion rate of almost 100% was reached, at the same polymerization temperature, 0.5 parts of diethylaminoethyl methacrylate and 3.5 parts of methyl methacrylate as polymerizable monomers for shell were added to the above-obtained dispersion liquid having core particles dispersed in the aqueous dispersion medium. Then, as a polymerization initiator for shell, 0-35 part of 2,2′-azobis-(2-methyl-N-(1,1-bis(hydroxymethyl) 2-hydroxyethyl)propionamide) (product name: VA-086; manufactured by: Wako Pure Chemical Industries, Ltd.) dissolved in 35 parts of ion-exchanged water was added, and polymerization reaction was further continued at 90° C. for three hours and stopped, thus obtained an aqueous dispersion of toner particles having a core-shell type structure and pH of 9.5.

While stirring the aqueous dispersion of toner particles thus obtained, sulfuric acid was added thereto to make pH 6 or less as an acid washing. After the mixture was dewatered by filtration, new ion-exchanged water was added by 500 parts to make the mixture Slurry again as a water washing. Dewatering and water washing were then repeated for several times. After separating solid content by filtration, the solid content was dried by a drier at 40° C. for two days and nights, thus obtained toner particles having a core-shell type structure.

To the toner particles having a core-shell type structure thus obtained of 100 parts, 1 part of silica having a volume average particle diameter of 12 nm and 1.5 parts of silica having a volume average particle diameter of 40 nm were added and mixed by means of HENSCHEL MIXER (product name) at 1,400 rpm for 10 minutes, thus produced a toner of Example 4.

### Comparative Examples 1 and 2

Toners of Comparative examples 1 and 2 were produced similarly as in Example 1 except that added amounts of the polymerizable monomers for shell were changed as mentioned in Table 1.

### Comparative Example 3

Into a container, 69 parts of styrene as a monovinyl monomer, 11 parts of butyl acrylate, 5 parts of diethylaminoethyl methacrylate and 5 parts of a cyan colorant (product name: FASTOGEN BLUE GCTF, C.I. Pigment Blue 15:3; manufactured by: Dainippon Ink & Chemicals, Inc.) were charged followed by preparatory dispersion by means of an in-line type emulsifying and dispersing machine (product name: MILDER; manufactured by: Ebara Corporation) as a preparatory dispersing machine at a rim speed of 23 m/s and 26 times of circulation frequency. A polymerizable monomer mixture for core thus obtained was subject to further dispersion by means of a media type dispersing machine (product name: PICO GRAIN MILL; manufactured by: Asada Iron Works. Co., Ltd,).

Next, to the polymerizable monomer mixture for core of 90 parts in which the cyan colorant was finely dispersed, 11 parts of styrene as a monovinyl monomer, 4 parts of butyl acrylate, 1.7 parts of a charge control resin having a positively charging ability (product name: 207P, constitutional repeating units comprising 2% of quaternary ammonium functional group; manufactured by: Fujikura Kasei Co., Ltd.), 0.5 part of polymethacrylic acid ester macromonomer (product name: AA6; manufactured by: Toagosei Co., Ltd.), 8 parts of dipentaerythritol hexamyristate as a release agent, 1.5 parts of t-dodecyl mercaptan as a molecular weight modifier and 0.5 part of divinylbenzene as a crosslinkable polymerizable monomer were added followed by stirring and dissolving, thus prepared a polymerizable monomer composition for core,

On the other hand, to an aqueous solution of 11.5 parts of magnesium chloride dispersed in 250 parts of ion-exchange water, an aqueous solution of 6.5 parts of sodium hydroxide dispersed in 50 parts of ion-exchange water was gradually added while stirring to prepare a magnesium hydroxide colloid dispersion liquid as an aqueous dispersion medium.

In the magnesium hydroxide colloid dispersion liquid thus obtained as an aqueous dispersion medium, the polymerizable monomer composition for core was poured and stirred. Thereafter, 5 parts of t-butylperoxy-2-ethylhexanoate (product name: PERBUTYL O; manufactured by: NOF Corporation) was charged into the mixture as a polymerization initiator. A high shear stirring was performed thereto at 15,000 rpm for 10 minutes by means of an in-line type emulsifying and dispersing machine (product name: MILDER; manufactured by: Ebara Corporation), thus obtained a suspension having droplets of the polymerizable monomer composition for core dispersed.

The suspension having droplets of the polymerizable monomer composition for core dispersed was charged into a reactor furnished with stirring vanes. While stirring the suspension, the temperature of the reactor was raised to polymerize the suspension. With controlling the temperature to be constant at 90° C., polymerization reaction was continued for five hours so as to reach a polymerization conversion rate of almost 100%, thus obtained a dispersion liquid having core particles dispersed in the aqueous dispersion medium.

When the polymerization conversion rate of almost 100% was reached, at the same polymerization temperature, 1 part of methyl methacrylate as a polymerizable monomer for shell was added to the above-obtained dispersion liquid having core particles dispersed in the aqueous dispersion medium. Then, as a polymerization initiator for shell, 0.35 part of 2,2′-azobis-(2-methyl-N-(1,1-bis(hydroxymethyl) 2-hydroxyethyl)propionamide) (product name: VA-086; manufactured by: Wako Pure Chemical Industries, Ltd.) dissolved in 35 parts of ion-exchanged water was added, and polymerization reaction was further continued at 90° C. for three hours and stopped, thus obtained an aqueous dispersion of toner particles having a core-shell type structure and pH of 9.5.

While stirring the aqueous dispersion of toner particles thus obtained, sulfuric acid was added thereto to make pH 6 or less as an acid washing. After the mixture was dewatered by filtration, new ion-exchanged water was added by 500 parts to make the mixture slurry again as a water washing. Dewatering and water washing were then repeated for several times. After separating solid content by filtration, the solid content was dried by a drier at 40° C. for two days and nights, thus obtained toner particles having a core-shell type structure.

To the toner particles having a core-shell type structure thus obtained of 100 parts, 1 part of silica having a volume average particle diameter of 12 nm and 1.5 parts of silica having a volume average particle diameter of 40 nm were added and mixed by means of HENSCHEL MIXER (product name) at 1,400 rpm for 10 minutes; thus produced a toner of Comparative example 3.

(Results)

The toners obtained by Examples 1 to 4 and Comparative examples 1 to 3 were subject to the tests according to the test methods (1) to (7) mentioned above. Table 1 shows properties and evaluation of each toner. Abbreviations in Table 1 are as follows: ST: styrene, BA: butyl acrylate; DE: diethylaminoethyl methacrylte; and MMA: methyl methacrylate.

TABLE 1

| | | | | Example | Example | Example | Example | Comparative | Comparative | Comparative |
|---|---|---|---|---|---|---|---|---|---|---|
| | | | | 1 | 2 | 3 | 4 | example 1 | example 2 | example 3 |
| Core | | ST | Part(s) | 81 | 81 | 81 | 81 | 81 | 81 | 80 |
| | | 8A | Part(s) | 19 | 19 | 19 | 19 | 19 | 19 | 15 |
| | | DE | Part(s) | 0 | 0 | 0 | 0 | 0 | 0 | 5 |
| | | Tg of | ° C. | 56.0 | 56.0 | 56.0 | 56.0 | 56.0 | 56.0 | 60.2 |
| | | copolymer | | | | | | | | |
| Shell | First | DE | Part(s) | 0 | 0 | 0 | 0 | 0 | 0 | 0 |
| | layer | MMA | Part(s) | 1 | 0.5 | 2 | 0 | 0 | 0 | 0 |
| | | Tg of | ° C. | 105 | 105 | 105 | — | — | — | — |
| | | copolymer | | | | | | | | |
| | Second | DE | Part(s) | 0.5 | 0.4 | 0.5 | 0.5 | 0 | 2 | 0 |
| | layer | MMA | Part(s) | 2.5 | 1.1 | 3.5 | 3.5 | 4 | 2 | 1 |
| | | Tg of | ° C. | 87.3 | 77.5 | 91.6 | 91.6 | 105.0 | 56.5 | 105.0 |
| | | copolymer | | | | | | | | |
| | Total | Monomer | Part(s) | 4 | 2 | 6 | 4 | 4 | 4 | 1 |
| | | Thickness | nm | 45 | 24 | 67 | 47 | 48 | 45 | 12 |
| | | Tg of | ° C. | 91.6 | 84.0 | 95.9 | 91.6 | 105.0 | 56.5 | 105.0 |
| | | copolymer | | | | | | | | |
| | Capsule | | | Two layers | Two layers | Two layers | Two layers | One layer | One layer | One layer |
| Toner | Properties | Dv | μm | 6.9 | 7.2 | 6.8 | 7.1 | 7.3 | 6.9 | 7.0 |
| particles | | Dv/Dp | | 1.19 | 1.18 | 1.23 | 1.20 | 1.20 | 1.21 | 1.22 |
| | | Circularity | | 0.979 | 0.977 | 0.982 | 0.981 | 0.979 | 0.980 | 0.978 |
| | | Q/M | μC/g | 42 | 35 | 41 | 40 | 30 | 51 | 33 |
| | Evaluation | Shelf stability | % | 2 | 6 | 2 | 3 | 4 | 40 | 15 |
| | | Minimum fixing | ° C. | 140 | 140 | 150 | 140 | 150 | 130 | 135 |
| | | temperature | | | | | | | | |
| | | Printing in | | 0.3 | 0.7 | 0.8 | 0.5 | 10 | 0.4 | 6.8 |
| | | early stage | | | | | | | | |
| | | Continuous | Prints | 10000< | 8000 | 10000< | 9000 | 10000< | 5000 | 6000 |
| | | printing | | | | | | | | |

(Summary of the Results)

The following are clear from test results shown in Table 1.

The toner of Comparative example 1 was produced without using diethylaminoethyl methacrylate specified in the present invention as a polymerizable monomer for shell. As the result, fogs occurred in the early stage of printing.

The toner of Comparative example 2 was produced to have a lower glass transition temperature than the range of the glass transition temperature of a shell layer specified in the present invention. As the result, the toner is inferior in shelf stability and fogs occurred in continuous printing.

The toner of Comparative example 3, which was produced by using, as a polymerizable monomer for core, diethylaminoethyl methacrylate specified in the present invention as a polymerizable monomer for shell. As the result, the toner is inferior in shelf stability and fogs occurred in the early stage of printing and continuous printing.

In contrast, since Examples 1 to 4 has used diethylaminoethyl methacrylate which is the polymerizable monomer for shell specified in the present invention, the toners obtained in Examples 1 to 4 are well-balanced between shelf stability and fixing ability at low temperature, and have excellent results on both printing in the early stage and continuous printing.

What is claimed is:

1. A method of producing a non-magnetic one-component toner for developing an electrostatic image comprising the steps of:
a suspension process (A) of obtaining a suspension having droplets of a polymerizable monomer composition for core dispersed by suspending the polymerizable monomer composition for core comprising at least a polymerizable monomer for core and a colorant in an aqueous dispersion medium containing a dispersion stabilizer;
a core particle forming process (B) of forming a core particle comprising a binder resin and a colorant by suspending and polymerizing the suspension in the presence of a polymerization initiator; and
a shell layer forming process (C) of forming a shell layer to cover the core particle by adding polymerizable monomers for shell to a core particle dispersion liquid having the core particles dispersed in an aqueous dispersion medium followed by polymerization in the presence of a polymerization initiator,
wherein, in the process (C), 0.1 to 10 parts by weight of a polymerizable monomer for shell containing at least a polymerizable tertiary amino compound having a structure represented by the following Chemical formula 1 with respect to the polymerizable monomer for core of 100 parts by weight is added to the core particle dispersion liquid as the polymerizable monomers for shell and polymerized, thereby, the shell layer comprising a polymer having a glass transition temperature from 70 to 120° C. is formed: 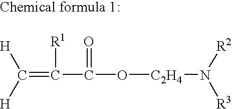
wherein, R¹, R² and R³ independently represent hydrogen or an alkyl group having 1 to 4 carbon atoms respectively.

2. The method of producing the non-magnetic one-component toner for developing an electrostatic image according to claim 1, wherein R² and R³ in the structure represented by the Chemical formula 1 independently represent an alkyl group having 2 or 3 carbon atoms respectively.

3. The method of producing the non-magnetic one-component toner for developing an electrostatic image according to claim 1, wherein a quantitative relationship between an amount “X” of the polymerizable tertiary amino compound having the structure represented by the Chemical formula 1 contained in the polymerizable monomers for shell and an amount “Y” of the other polymerizable monomer contained in the polymerizable monomers for shell fulfills the following Calculation formula 1:
0.05<(X/Y)<1.0 Calculation formula 1:

4. The method of producing the non-magnetic one-component toner for developing an electrostatic image according to claim 1, wherein a thickness of the shell layer is from 5 to 150 nm.

5. The method of producing the non-magnetic one-component toner for developing an electrostatic image according to claim 1, wherein a charge amount “Q/M” per unit weight of the non-magnetic one-component toner for developing an electrostatic image on a surface off a developing roller is from 20 to 80 μC/g.

6. The method of producing the non-magnetic one-component toner for developing an electrostatic image according to claim 1, wherein the shell layer forming process (C) comprises two stages.

7. The method of producing the non-magnetic one-component toner for developing an electrostatic image according to claim 6, wherein, in the shell layer forming process (C), a glass transition temperature of the shell layer (the second layer) to be formed in the second stage is adjusted to be lower than that of the shell layer (the first layer) to be formed in the first stage though a glass transition temperature of the whole shell layers is set in the range from 70 to 120° C.

8. The method of producing the non-magnetic one-component toner for developing an electrostatic image according to claim 7, wherein the glass transition temperature of the shell layer to be formed in the first stage is in the range from 90 to 120° C.

9. The method of producing the nonmagnetic one-component toner for developing an electrostatic image according to claim 7, wherein the glass transition temperature of the shell layer to be formed in the second stage is in the range from 70 to 100° C.

10. The method of producing the non-magnetic one-component toner for developing an electrostatic image according to claim 7, wherein a ratio of the shell layer to be formed in the first stage and the shell layer to be formed in the second stage is in the range from 10:90 to 90:10.

11. The method of producing the non-magnetic one-component toner for developing an electrostatic image according to claim 1, wherein a weight of the toner remained after storing at 55° C. for 15 hours and vibrated on a screen at an amplitude of 1.0 mm for 30 seconds is less than 15% with respect to a weight of the toner before storing.

12. The method of producing the non-magnetic one-component toner for developing an electrostatic image according to claim 1, wherein an initial fog value of the toner is 1.0 or less, in which the initial fog value is a color difference ΔE of the toner after being left under a NN environment for one day followed by solid pattern printing with 0% image density with respect to a benchmark sample.

13. The method of producing the non-magnetic one-component toner for developing an electrostatic image according to claim 1, wherein number of prints with image quality having an initial fog value of 1.0 or less maintained is 8,000 prints, in which the initial fog value is a color difference ΔE of the toner after being left under a NN environment for one day followed by solid pattern printing with 0% image density with respect to a benchmark sample.

14. The method of producing the non-magnetic one-component toner for developing an electrostatic image according to claim 1, wherein a minimum fixing temperature having a fixing rate of more than 80% of the toner is 140 to 150° C.

15. The method of producing the non-magnetic one-component toner for developing an electrostatic image according to claim 1, wherein a volume average particle diameter “Dv” of the toner is in the range from 3 to 15 μm.

16. The method of producing the non-magnetic one-component toner for developing an electrostatic image according to claim 1, wherein a number-based percentage of the toner particles with a particle diameter of 5 μm or less is 25% or less.

17. The method of producing the non-magnetic one-component toner for developing an electrostatic image according to claim 1 wherein a ratio “Dv/Dp” of the volume average particle diameter “Dv” and a number average particle diameter “Dp” of the toner is in the range from 1.0 to 1.3.

18. The method of producing the non-magnetic one-component toner for developing an electrostatic image according to claim 1, wherein a glass transition temperature (Tg) of the polymer constituting the core particle is in the range from 30 to 65° C.

19. The method of producing the non-magnetic one-component toner for developing an electrostatic image according to claim 1, wherein a glass transition temperature (Tg) of the polymer constituting the shell layer is in the range from 80 to 110° C.

20. The method of producing the non-magnetic one-component toner for developing an electrostatic image according to claim 1, wherein an in situ polymerization method is used in the shell layer forming process (C).
